(19) United States
(12) Patent Application Publication
(10) Pub. No.: US 2005/0212739 A1
(43) Pub. Date: Sep. 29, 2005

(54) Driving circuit for liquid crystal device

(75) Inventor: Takuya Kawakami, Osaka-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka-shi (JP)

(21) Appl. No.: 11/085,143

(22) Filed: Mar. 22, 2005

(30) Foreign Application Priority Data
Mar. 29, 2004 (JP) 2004-095134

(51) Int. Cl. G09G 3/36

(52) U.S. Cl. 345/89

(57) ABSTRACT

The invention provides a driving circuit for a liquid crystal device having a reduced number of transistor elements by sharing transistors having identical logics among adjacent decoders. The driving circuit for a liquid crystal device capable of carrying out gradation display by applying gradation voltage corresponding to a display data to a liquid crystal element comprises a decoder circuit portion composed of a dynamic circuit for selecting the gradation voltage, the decoder circuit portion having a number of transistor elements 4 reduced by sharing transistors with identical logics constituting adjacent decoders. The voltage level corresponding to the display data causes all the analog switches to be set to an off status, so as to prevent overlap of output voltage during a timing of transition of the analog switch to the off status and a timing by which the analog switch is turned on according to a subsequent display data.

The present application is based on and claims priority of Japanese patent application No. 2004-095134 filed on Mar. 29, 2004, the entire contents of which are hereby incorporated by reference.

### BACKGROUND OF THE INVENTION

1. Field of the Invention

The present invention relates to a driving circuit for a liquid crystal device, and specifically, to a driving circuit for a liquid crystal device capable of selecting necessary gradation data by a decoder circuit portion and carrying out gradation display.

2. Description of the Related Art

The driving circuit for a liquid crystal device according to the prior art will now be described. FIG. 2 shows one example of a prior art driving circuit for a liquid crystal device. If the digital display data input to the driving circuit of the liquid crystal device is a 260,000-color display data composed of RGB (three primary colors, which are R (red), G (green) and B (blue)) each represented by six bits, there will be sixty-four varieties of digital data, from [000000], [000001] to [111110] and [111111], to be input to the driving circuit.

In response to the input digital data, a decoder circuit portion turns on a single analog switch out of the sixty-four analog switches, selects a voltage level corresponding to the display data, and applies the voltage to a liquid crystal element.

Normally, each analog switch 2 is formed of a combination of a Pch (channel) transistor and an Nch (channel) transistor. However, there is a demand to downsize the driving circuit IC chip of the liquid crystal device along with the downsizing of the mounting area of a COG (chip on glass) to be mounted on the glass of the liquid crystal panel and the increase of display resolution. Therefore, according to the prior art, the decoder circuit portion adopts a dynamic circuit arrangement, as illustrated in the area surrounded by the dashed line of FIG. 2, in order to simplify the circuit and reduce the chip size.

Japanese Patent Application Laid-Open Publication No. 11-231839 (patent document 1) also aims at reducing the number of elements, but it does not mean that the disclosed technique reduces the number of transistors constituting the decoder circuit portion. Patent document 1 discloses a circuit for outputting and supplying voltage to a liquid crystal element, wherein an 8-bit decoder is rearranged into a 6-bit decoder, the data corresponding to two high order bits are used to turn on and off the switch of a switched capacitor disposed at a subsequent stage, and by combining the same with the voltage selected based on the 6-bit decoder, an integrator with a condenser connected in parallel with an amplifier is formed.

In order to correspond to the resolution of the liquid crystal panel, the IC for driving the liquid crystal panel must incorporate a large number of driving circuits corresponding to the resolution of the source (data-side) of the liquid crystal panel, and thus, it will have the same number of output terminals. For example, in the case of a 240×3 (RGB)×320 color QVGA (quarter VGA; VGA: 480×3 (RGB)×640) as illustrated in FIG. 3, the IC will have 240×3=720 circuits and 720 output terminals. As described, the conventional driving circuit constituting the IC for driving the liquid crystal panel is composed of multiple orderly arranged circuits, which in the above case are 720 circuits. However, along with the demand to downsize the liquid crystal panel, it is indispensable to downsize and optimize the size of the chip. The reduction of transistor elements will have a significant impact on the chip size.

According to the above-mentioned decoder circuit portion adopting the dynamic circuit arrangement, each analog switch 2 outputting gradation voltage has independent transistors corresponding to the data bus bits. According to this arrangement, there are a number of sharable portions taking up a large circuit area, obstructing the downsizing of the circuit area.

### SUMMARY OF THE INVENTION

In order to solve the problems of the prior art, the present invention aims at providing a driving circuit for a liquid crystal device according to which the transistors having-identical logics among adjacent decoders are shared, by which the number of transistor elements can be reduced significantly.

The present invention provides a driving circuit for a liquid crystal device capable of carrying out gradation display by applying gradation voltage corresponding to a display data to a liquid crystal element, the driving circuit comprising a decoder circuit portion composed of a dynamic circuit for selecting the gradation voltage, the decoder circuit portion having a number of transistor elements reduced by sharing transistors with identical logics constituting adjacent decoders.

Moreover, the present invention provides a driving circuit for a liquid crystal device, wherein prior to applying voltage to the liquid crystal element, the voltage level corresponding to the display data causes all the analog switches to be set to an off status, so as to prevent overlap of output voltage during transition of the analog switch to the off status and during transition of the analog switch to the on status according to a subsequent display data.

According to the present invention, the number of transistor elements per one output of the decoder circuit portion constituting the driving circuit for the liquid crystal deice was reduced from 448 to 127, which is a reduction of approximately 28%. The reduction of the transistors according to the present invention enables the chip to be downsized, which further enables the chip costs to be reduced and the mounting area on the liquid crystal panel to be downsized, and as a result, enables the casing of the liquid crystal panel to be downsized.

The downsizing of the casing of the liquid crystal panel results in the increase of the number of liquid crystal glass panels to be obtained from a single material glass plate, according to which the costs of the liquid crystal panel can be cut down.

### BRIEF DESCRIPTION OF THE DRAWINGS

FIG. 1 is an explanatory view showing a driving circuit for a liquid crystal device according to a preferred embodiment of the present invention;

FIG. 2 is an explanatory view of a prior art driving circuit for a liquid crystal device according to the prior art;

FIG. 3 is an explanatory view showing one example of a liquid crystal panel; and

FIG. 4 is an explanatory view showing an example of the operation timing of the driving circuit for the liquid crystal device.

### DETAILED DESCRIPTION OF THE PREFERRED EMBODIMENTS

The preferred embodiment of the present invention will now be described.

An embodiment of the driving circuit for a liquid crystal device according to the present invention will be described with reference to the drawings.

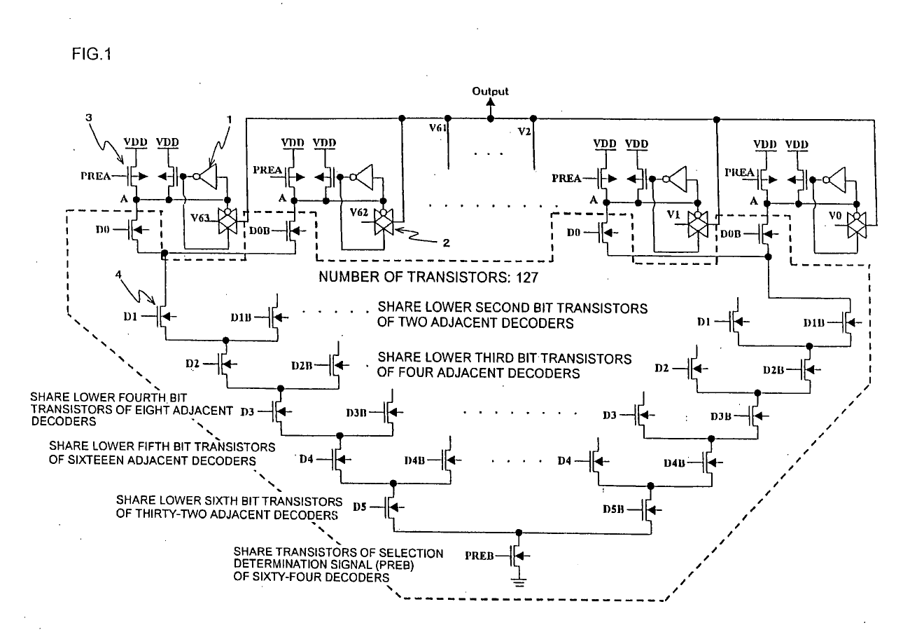

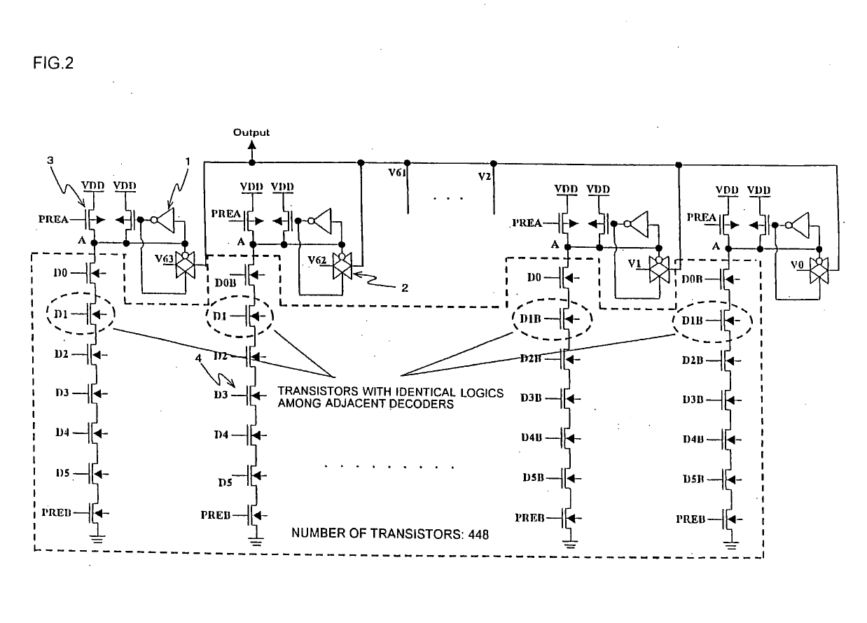

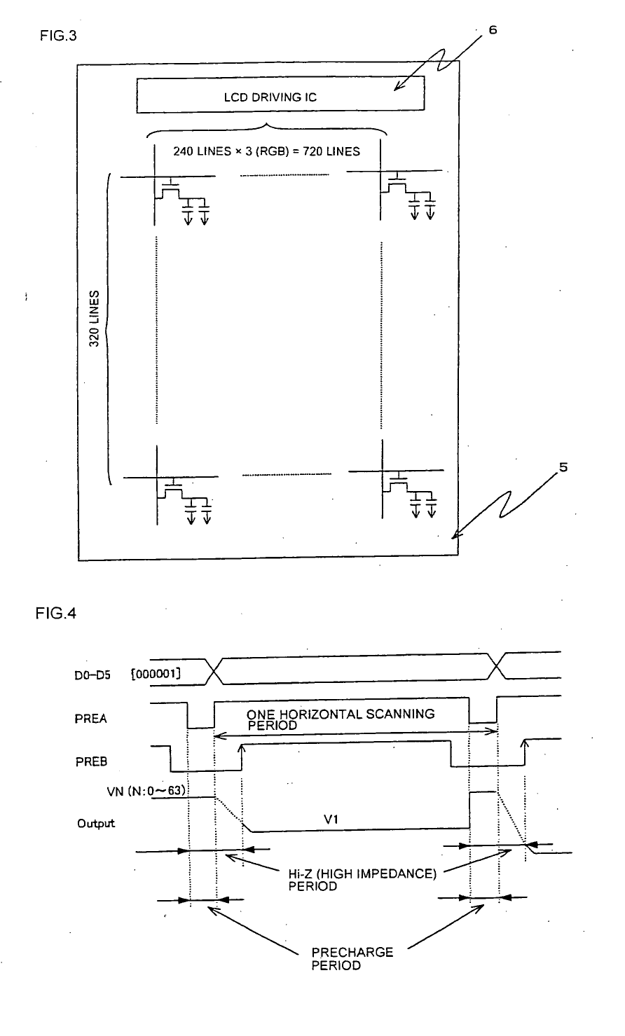

The driving circuit for a liquid crystal device according to the present invention will be described in comparison with the prior art driving circuit for a liquid crystal device. FIG. 1 is a driving circuit for a liquid crystal device according to the present embodiment, and FIG. 2 shows one example of a prior art driving circuit for a liquid crystal device. The following description refers to a six bit arrangement merely illustrated as an example.

According to the prior art driving circuit for a liquid crystal device, there are sixty-four voltage levels (V0 through V63), and since a single voltage level is composed of seven transistors, the circuit is composed of:
(sixty-four voltage levels)×(seven transistors)=448 transistors per one output.

On the other hand, according to the driving circuit for a liquid crystal device of the present embodiment, there are sixty-four voltage levels (V0 through V63) of output, and the circuit is composed of analog switches 2 for selecting the voltage level, a total of seven transistors, six transistors constituting a decoder circuit and one transistor controlling the decoder output, and a precharge transistor for preventing overlap of liquid crystal driving voltages.

The driving circuit for a liquid crystal device according to the present embodiment is designed to sequentially share the transistors having identical logics among adjacent decoders in the prior art circuit illustrated in FIG. 2. In the present driving circuit, the lower second bit transistors of two adjacent decoders are shared. Further according to the present driving circuit, the lower third bit transistors of four adjacent decoders, the lower fourth bit transistors of eight adjacent decoders, the lower fifth bit transistors of sixteen adjacent decoders, the lower sixth bit transistors of thirty-two adjacent decoders, and the selection determination signal (PREB) transistors of sixty-four adjacent decoders are shared, respectively. Therefore, the driving circuit of the present embodiment requires only 64+32+16+8+4+2+1=127 transistors. That is, the required number of transistors according to the present embodiment is reduced to 127, as illustrated in FIG. 1, as compared to the 448 transistors according to the prior art circuit in the area defined by the dashed line of FIG. 2.

According to the driving circuit for a liquid crystal device, the six-bit data as display data are connected to six transistors respectively corresponding to each voltage level, and when the output control transistor is turned on, the analog switch of the voltage level for which all six transistors are on are turned on, according to which the voltage level selected by the driving circuit is output.

For example, if a voltage level of V1 is to be output, the display data being input is a digital data represented by [D0, D1, D2, D3, D4, D5]=[100000]. However, the input to the six transistors connected to V1 receiving the display data is represented by: D0=“1”, D1B=“1”, D2B=“1”, D3B=“1”, D4B=“1”, and D5B=1. Here, D1B denotes an inverted signal of D1.

Prior to applying the voltage level corresponding to the display data to the liquid crystal element, it is necessary to set all the analog switches 2 to the off status (in which nodes A of FIGS. 1 and 2 are set to VDD level and all analog switches 2 are turned off), in order to prevent overlap of the timing of transition of the analog switches 2 to the off status and the timing by which the analog switches 2 are turned on by the subsequent display data (in other words, to prevent simultaneous timing thereof). Thus, a precharge period (refer to FIG. 4) is provided at the head of one horizontal scanning period of a PREA signal. When the PREA is “0”, the Pch transistor to which the PREA signal is connected is turned on, and all the analog switches 2 are turned off.

According to the subsequently input digital data [D0, D1, D2, D3, D4, D5]=[100000], only the six transistors connected to V1 receiving the display data are all turned on. Then, by turning on the transistor connected to PREB at a given timing, the analog switch 2 corresponding to V1 is turned on, according to which V1 is selected and the voltage level of V1 is output through the output.

Incidentally, in the example of the operation timing of the driving circuit for the liquid crystal device shown in FIG. 4, the period starting when the PREA is turned to “1” and ending when the next PREA is turned to “1” is defined as one horizontal scanning period, and the period starting when the PREA is turned to “0” and ending when the PREB is turned to “1” is defined as a Hi-Z (high impedance) period.

1. A driving circuit for a liquid crystal device capable of carrying out gradation display by applying gradation voltage corresponding to a display data to a liquid crystal element, the driving circuit comprising:
a decoder circuit portion composed of a dynamic circuit for selecting the gradation voltage, the decoder circuit portion having a number of transistor elements reduced by sharing transistors with identical logics constituting adjacent decoders.

2. The driving circuit for a liquid crystal device according to claim 1, wherein prior to applying voltage to the liquid crystal element, the voltage level corresponding to the display data causes all the analog switches to be set to an off status, so as to prevent overlap of output voltage during a timing of transition of the analog switch to the off status and a timing by which the analog switch is turned on according to a subsequent display data.
